(19) United States
(12) Patent Application Publication
(10) Pub. No.: US 2024/0331001 A1
(43) Pub. Date: Oct. 3, 2024

(54) CONTENT TRANSACTION PLATFORM

(71) Applicant: A&H COPORATION, Ansan-si, Gyunggi-do (KR)

(72) Inventor: Gue Dae GU, Namyangjyu-si, Gyunggi-do (KR)

(73) Assignee: A&H COPORATION, Ansan-si, Gyunggi-do (KR)

(21) Appl. No.: 18/708,532

(22) PCT Filed: Nov. 8, 2021
(86) PCT No.: PCT/KR2021/016126

§ 371 Date: May 8, 2024

(51) Int. Cl. G06Q 30/0601; G06Q 20/12

(52) U.S. Cl. CPC G06Q 30/0625; G06Q 20/123; G06Q 30/0621; G06Q 30/0643

(57) ABSTRACT

Proposed is a content transaction platform for content transactions between content providers who create contents and consumers who use contents, wherein the content transaction platform includes a content source for managing contents uploaded by content providers, and provides a personalized content for each consumer according to a result of analyzing the consumer's behaviors and interest levels.

### TECHNICAL FIELD

The present disclosure relates to a content transaction platform. More particularly, the present disclosure relates to a content transaction platform for content transactions between content providers who create contents and consumers who use contents.

### BACKGROUND ART

For example, advertisements using digital media or prints may be created using various contents.

Advertisements, such as signage, using digital media may be represented using layouts, tags, images, videos, menus, and application programming interfaces (APIs). In the above, an API may be understood to be an interface programmed for advertising. For example, an API may be an interface that shows detailed information of a product when a tag therefor is selected.

When a consumer plans an advertisement, various contents to be included in the advertisement are required.

To this end, it is necessary to provide an environment in which contents can be purchased and sold between consumers and content providers without limitations.

A content transaction platform for providing the environment needs to have functions of allowing content providers to upload various contents for sale and suggesting suitable contents to consumers.

### DISCLOSURE

### Technical Problem

The present disclosure is directed to providing a content transaction platform capable of realizing a sharing economy through autonomous transactions of contents between consumers and content providers.

In addition, the present disclosure is directed to providing a content transaction platform capable of easily finding a content that a consumer wants by using consumer pattern information.

In addition, the present disclosure is directed to providing a content transaction platform that has a function of allowing a consumer to select a recommended personalized content and then edit the content or then invite tenders for editing, so that the consumer can purchase a content he or she wants.

In addition, the present disclosure is directed to providing a content transaction platform capable of making a request for editing through a tender when a consumer wants editing of a content, and performing charging accordingly.

In addition, the present disclosure is directed to providing a content transaction platform allowing a content provider to perform editing and delivery in a trusted environment when a consumer request editing of a content through a tender.

### Technical Solution

According to the present disclosure, there is provided a content transaction platform including: a content source configured to store and manage contents uploaded by a plurality of content providers; a consumer interface part configured to provide a consumer interface page through the Internet, the consumer interface page forming an interface for a consumer to search, purchase, and edit the contents; a personalized content provision part configured to provide a search tool, select one or a plurality of personalized contents among the contents of the content source using consumer pattern information in association with the consumer's search using the search tool, and provide the selected personalized content to the consumer interface part; an editing part configured to provide an editing tool, generate an edited content through the consumer's editing of the personalized content using the editing tool, and provide the edited content to the consumer interface part; a purchase part configured to provide a purchase tool, and provide purchase decision information including payment information in association with the consumer's purchase of the personalized content or the edited content using the purchase tool; and a consumer information management part configured to generate the consumer pattern information by collecting and analyzing the consumer's behaviors for the search through the consumer interface part and the consumer's interest levels in the contents provided through the search tool, and manage purchase information corresponding to the purchase decision information.

In addition, according to the present disclosure, there is provided a content transaction platform including: a content source configured to store and manage contents uploaded by a plurality of content providers; a consumer interface part configured to provide a consumer interface page through the Internet, the consumer interface page forming an interface for a consumer to search the contents, invite tenders, and purchase the contents; a provider interface part configured to provide a provider interface page through the Internet, the provider interface page forming an interface for the content provider to upload the content and make the tender; an uploading part configured to provide an uploading tool, the uploading tool uploading the content to the content source in response to an upload request of the content provider; a personalized content provision part configured to provide a search tool, select one or a plurality of personalized contents among the contents of the content source using consumer pattern information in association with the consumer's search using the search tool, and provide the selected personalized content to the consumer interface part; a tender part configured to provide a tender tool for relaying the tender between the consumer and the content provider, the tender tool making an edit request of the consumer interface part for the personalized content, an order request of the provider interface part in association with the edit request, an editing order from the consumer interface part in association with the order request, a delivery of an edited content by the provider interface part in association with the editing order, and provision of the edited content delivered to the consumer interface part; a purchase part configured to provide a purchase tool, and provide purchase decision information including payment information in association with the consumer's purchase of the personalized content or the edited content using the purchase tool; a consumer information management part configured to generate the consumer pattern information by collecting and analyzing the consumer's behaviors for the search through the consumer interface part and the consumer's interest levels in the contents provided through the search tool, and manage purchase information corresponding to the purchase decision information; and a provider information management part configured to manage uploading information of the content and sale information corresponding to the purchase information of the consumer.

### Advantageous Effects

According to the present disclosure, the content transaction platform can realize a sharing economy through autonomous and horizontal transactions of contents between consumers and content providers.

In addition, according to the present disclosure, a personalized content can be provided using consumer pattern information, and a content that a consumer wants can be easily found accordingly.

In addition, according to the present disclosure, a consumer can edit a personalized content or invites tenders for editing. Therefore, an accurate content that a consumer wants can be provided, and content providers can create additional income.

In addition, according to the present disclosure, when a consumer makes a request for editing of a content, deposit processing is performed so that a content provider can perform editing and delivery in a trusted environment.

### DESCRIPTION OF DRAWINGS

FIG. 1 is a block diagram illustrating the concept of a content transaction platform according to the present disclosure.

FIG. 2 is a block diagram illustrating an embodiment of the content transaction platform of FIG. 1.

FIG. 3 is a flowchart illustrating an example of a content transaction method using the embodiment of FIG. 2.

FIG. 4 is a flowchart illustrating another example of a content transaction method using the embodiment of FIG. 2.

FIG. 5 is a block diagram illustrating another embodiment of the content transaction platform of FIG. 1.

FIG. 6 is a flowchart illustrating an example of a content transaction method using the embodiment of FIG. 5.

FIG. 7 is a flowchart illustrating another example of a content transaction method using the embodiment of FIG. 5.

### MODE FOR INVENTION

Hereinafter, preferred embodiments of the present disclosure will be described in detail with reference to the accompanying drawings. The terms used in this specification and in the claims should not be construed as limited to their ordinary or dictionary sense, but should be construed with meanings and concepts consistent with the technical details of the present disclosure.

Embodiments described in the present specification and configurations illustrated in the drawings are preferred embodiments of the present disclosure, and do not represent the entire technical idea of the present disclosure. Thus, various equivalents and modifications capable of replacing the embodiments and configuration may be provided at the point of time that the present application is filed.

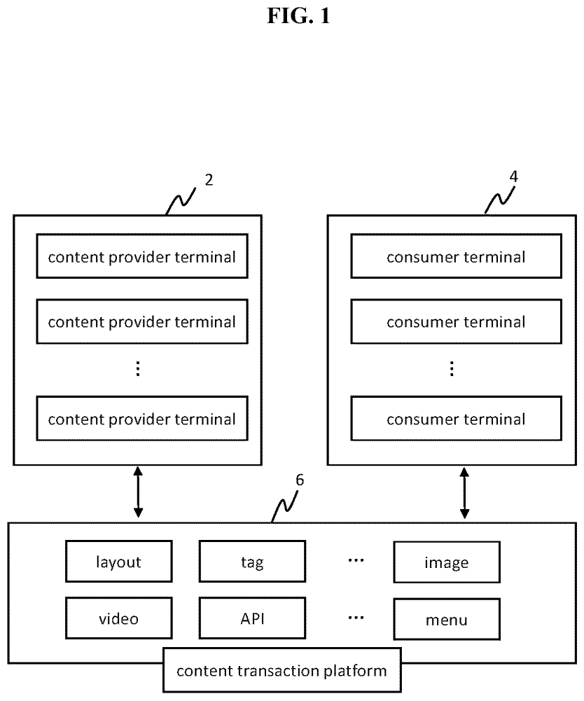

The concept of a content transaction platform according to the present disclosure may be understood with reference to FIG. 1.

The content transaction platform according to the present disclosure is implemented to realize a sharing economy through autonomous and horizontal transactions of contents between consumers and content providers.

FIG. 1 illustrates that a content provider group 2 includes a plurality of content provider terminals a plurality of content providers use and a consumer group 4 includes a plurality of consumer terminals a plurality of consumers use.

Each content provider terminal may be understood to correspond to a content provider, and the content provider means a person who creates and provides a content for sale. In addition, each consumer terminal may be understood to correspond to a consumer, and the consumer means a person who purchases a content to create an advertisement.

In addition, it is illustrated that a content transaction platform 6 includes a content source 100 that stores and manages contents uploaded for sale. The content source 100 may be understood to be a medium for storing various contents for use in advertising. Herein, the contents may include, for example, layout, tag, image, video, menu, and application programming interface (API) data that may be used in creating advertisements.

The content transaction platform 6 may communicate with the content provider group 2 and the consumer group 4 over the Internet generally.

The content transaction platform 6 may be understood to be a server that is on the wired or wireless Internet generally. In addition, the content provider terminals of the content provider group 2 and the consumer terminals of the consumer group 4 may be various terminals that can access the Internet in a wired or wireless manner. For example, various terminals, such as desktop computers, laptop computers, mobile terminals, smart pads, and smart phones, may be used as the content provider terminals and the consumer terminals.

In the content transaction platform 6, the content source 10 manages the contents uploaded by the content providers, a personalized content for each consumer is generated according to a result of analyzing behaviors and interest levels of a consumer, and consumer pattern information is used to provide a personalized content selected among the contents. Herein, the consumer pattern information may be provided on the basis of artificial intelligence, for example.

There are four embodiments of how a user purchases a content according to the present disclosure. A first embodiment may be defined as purchasing a personalized content as it is. In addition, a second embodiment may be defined as purchasing an edited content resulting from editing a personalized content. In addition, a third embodiment may be defined as inviting tenders to content providers related to a personalized content, then making a request to a selected content provider for an editing work, and purchasing an edited content resulting from editing the personalized content. In addition, a fourth embodiment may be defined as inviting open tenders to provide the details of editing for a personalized content to a plurality of content providers, then making a request to a selected content provider for editing, and purchasing an edited content resulting from editing the personalized content.

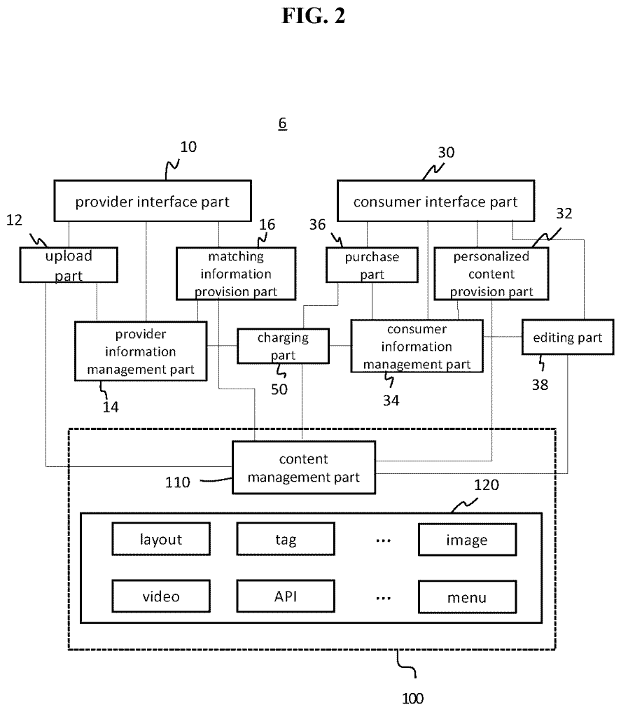

The first embodiment and the second embodiment may be described with reference to the block diagram of FIG. 2.

The content transaction platform 6 of FIG. 2 includes the content source 100 illustrated in FIG. 1.

The content source 100 includes a content management part 110 and a content database 120.

Herein, the content database 120 may be regarded as a storage source that stores layout, tag, image, video, menu, and application programming interface (API) data classified according to a preset classification system.

In addition, the content management part 110 may be regarded as a gate between the content database 120 and the outside. That is, the content management part 110 may perform functions such as uploading to the content database 120 on external requests, providing uploaded contents to the content database 120, or conducting analysis of contents and providing the same.

For convenience of description, in the following detailed description of the present disclosure, the content source 100 is described as a combination of the functions of the content management part 110 and the content database 120. That is, the content source 100 may be understood to store and manage contents uploaded by a plurality of content providers.

In addition, the content transaction platform 6 includes a provider interface part 10, an uploading part 12, a provider information management part 14, a matching information provision part 16, a consumer interface part 30, a personalized content provision part 32, a consumer information management part 34, a purchase part 36, an editing part 38, a charging part 50, and the content source 100.

Among them, the provider interface part 10, the uploading part 12, the provider information management part 14, and the matching information provision part 16 are elements for content providers, and the consumer interface part 30, the personalized content provision part 32, the consumer information management part 34, the purchase part 36, and the editing part 38 are elements for consumers.

In addition, the charging part 50 may perform charging processing in association with purchase decision information of the purchase part 36. The charging part 50 may generate purchase information and sale information corresponding to the charging processing, and may provide the purchase information to the consumer information management part 34 and the sale information to the provider information management part 14.

First, the elements for consumers will be described.

The consumer interface part 30 provides a consumer interface page over the Internet. The consumer interface page may be understood to be a web page or app page browsed on a consumer terminal of a consumer. That is, the consumer interface page is to form an interface of a consumer who has gained access over the Internet, and may be understood to have functions for the consumer to search, purchase, and edit contents.

In addition, the personalized content provision part 32 provides a search tool to the consumer interface page. Herein, the search tool may be realized within the consumer interface page or realized as a separate page linked to the consumer interface page. The search tool provides a function for searching, such as keyword search.

In association with a search by a consumer using the search tool, the personalized content provision part 32 selects one or a plurality of personalized contents among the contents of the content source 100, and provides the selected personalized content to the consumer interface part 30. The personalized content provision part 32 may select a personalized content using consumer pattern information provided from the consumer information management part 34. The consumer pattern information may be generated and provided by the consumer information management part 34, which will be described later.

The editing part 38 provides an editing tool to the consumer interface page. Herein, the editing tool may be realized within the consumer interface page or realized as a separate page linked to the consumer interface page. The editing tool provides functions of fetching a personalized content, providing tools required in editing a personalized content, and storing an edited content.

The editing part 38 generates an edited content based on the editing of a personalized content by a consumer using the editing tool, and provides the edited content to the consumer interface part 30. Herein, providing the edited content to the consumer interface part 30 may be realized by storing the personalized content in a designated location linked to the consumer interface part 30.

The purchase part 36 provides a purchase tool to the consumer interface page. Herein, the purchase tool may be realized within the consumer interface page or realized as a separate page linked to the consumer interface page. The purchase tool provides functions of fetching payment information for purchase from the consumer information management part 34, and generating purchase decision information including payment information, a payment target, and a payer.

The purchase part 36 may provide the purchase decision information including payment information in association with the purchase of a personalized content or an edited content by a consumer using the purchase tool.

The consumer information management part 34 analyzes a consumer's behaviors and interest levels by collecting the consumer's previously collected interest fields, keywords used by the consumer for search, and categories and information of contents read by the consumer from the consumer interface part 30.

More specifically, the consumer information management part 34 may obtain the consumer's interest fields in advance through the consumer interface page of the consumer interface part 30.

In addition, the consumer information management part 34 may manage basic information including a consumer's personal information, and financial information of a consumer for purchase, and consumer pattern information. The financial information may include payment information for purchase and purchase information corresponding to a result of performing charging processing on purchase decision information.

In addition, the consumer pattern information may be generated by collecting the basic information of the consumer, the keywords used by the consumer for search, and the categories and information of contents read by the consumer from the consumer interface part 30 and by analyzing the consumer's behaviors and interest levels.

In the meantime, the elements for content providers will be described.

The provider interface part 10 provides a provider interface page over the Internet. The provider interface may be understood to be a web page or app page browsed on a terminal of a content provider. That is, the provider interface page is to form an interface of a content provider who has gained access over the Internet, and may be understood to have functions for the content provider to upload a content and collect information.

In addition, the uploading part 12 provides an uploading tool to the provider interface page. Herein, the uploading tool may be realized within the provider interface page or realized as a separate page linked to the provider interface page. The uploading tool has a function required in uploading a content.

That is, in response to an upload request of a content provider through the provider interface page, the uploading part 12 uploads a content to the content source 100 through the uploading tool.

The matching information provision part 16 is for providing content information corresponding to request information including a condition pre-registered by a content provider by searching a plurality of contents of the content source 100. For example, the matching information provision part 16 may be used for advance collection of interest fields, collection of newly revealed contents, collection of consumers' grades, or collection of popular content rankings.

The provider information management part 14 may manage and provide the request information of the content provider to the matching information provision part 16, and may manage uploading information of a content and sale information corresponding to purchase information of a consumer.

More specifically, the provider information management part 14 manages request information of a content provider, uploading information of a content, sale information of a content, basic information including personal information of a content provider, and financial information of a content provider. Herein, the financial information may be understood to include payment information to be provided to the charging part for charging processing.

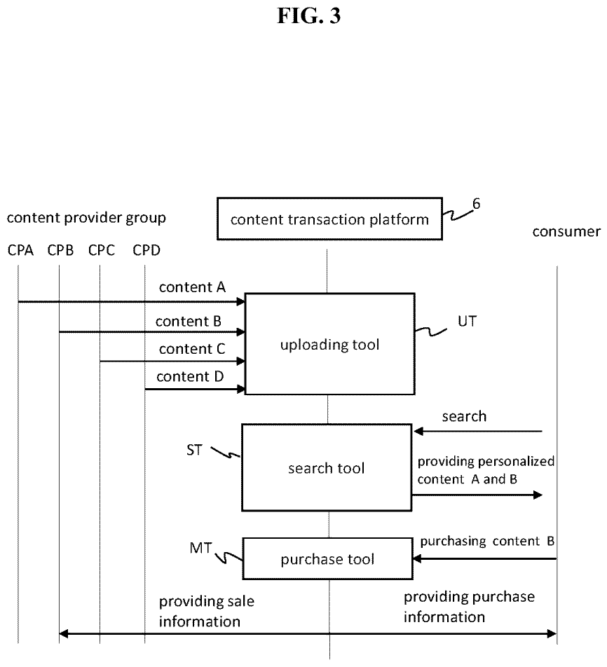

The operation of the first embodiment based on the configuration of FIG. 2 described above may be described with reference to FIG. 3. For description of an embodiment, content providers included in a content provider group are classified into CPA, CPB, CPC, and CPD, and the operations of content providers CPA, CPB, CPC, and CPD may be understood to be performed using content provider terminals. In addition, the operation of a consumer may be understood to be performed using a consumer terminal.

Content providers CPA, CPB, CPC, and CPD may use the uploading tool (UT) of the uploading part 12 to upload contents for sale to the content source 10. Content provider CPA uploads Content A, Content provider CPB uploads Content B, Content provider CPC uploads Content C, and Content provider CPD uploads Content D.

The uploading part 12 updates uploading information of the provider information management part 14 when a content is uploaded to the content source 10, thereby managing uploading records of contents. In addition, the uploading record may be checked through the provider interface part 10.

The consumer may search for a content required in planning an advertisement through the search tool (ST) of the consumer interface part 30.

In the searching process, keywords used by the consumer to search for a content and categories and information of contents read by the consumer may be collected by the user information management part 34, and may be used in generating and updating consumer pattern information according to analysis of the consumer's behaviors and interest levels.

By referring to the consumer pattern information of the consumer information management part 34, the personalized content provision part 32 may provide a personalized content corresponding to the consumer's search through the search tool (ST).

The personalized content provision part 32 may provide a single or a plurality of personalized contents. For example, the personalized content provision part 32 may provide Content A and Content B as personalized contents.

The consumer may select the one he or she wants among the provided personalized contents, and may purchase Content B that is a personalized content selected as an example, through the purchase tool (MT) provided by the purchase part 36.

The purchase part 36 may obtain payment information from the consumer information management part 34 in association with the purchase of the personalized content by the consumer, and may provide purchase decision information including the payment information to the charging part 50.

The charging part 50 performs charging processing for the purchase of Content B in association with the purchase decision information of the purchase part 36 and generates purchase information and sale information, and provides the purchase information to the consumer information management part 34 and the sale information to the provider information management part 14.

Through the charging processing by the charging part 50, the consumer may purchase Content B that is a personalized content. The purchase information on the purchase of Content B may be provided to the consumer information management part 34. The consumer information management part 34 may manage a record of purchased contents. In addition, the sale information is provided to the provider information management part 14 and is included in a sale record of Content provider CPB who has uploaded Content B.

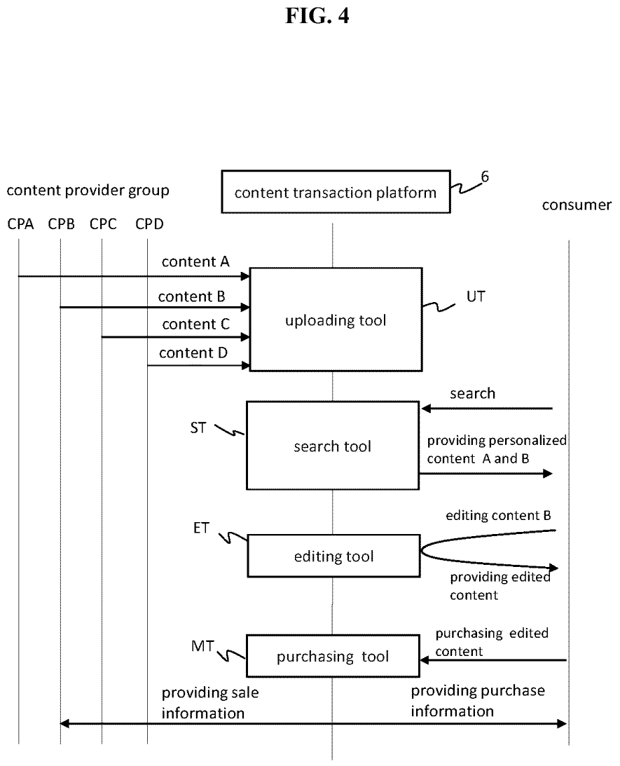

In the meantime, the operation of the second embodiment based on the configuration of FIG. 2 described above may be described with reference to FIG. 4. In FIG. 4, uploading contents by a content provider group, searching for a content by a consumer, and providing a personalized content by the search tool (ST) are the same as in FIG. 3, so a redundant description thereof will be omitted.

In the second embodiment, a consumer may select the one he or she wants among personalized contents, and may edit the personalized content to make the personalized content suitable for use and then purchase the edited content.

That is, the consumer may fetch a selected personalized content into the editing tool (ET), and may use tools provided in the editing tool (ET) to edit the personalized content to make the personalized content suitable for use. After finishing editing, the consumer may store the edited content, and then may purchase the edited content.

The purchase part 36 may obtain payment information from the consumer information management part 34 in association with the purchase of the edited content by the consumer, and may provide purchase decision information including the payment information to the charging part 50.

The charging part 50 performs charging processing for the purchase of the edited content in association with the purchase decision information of the purchase part 36 and generates purchase information and sale information, and provides the purchase information to the consumer information management part 34 and the sale information to the provider information management part 14.

Through the charging processing by the charging part 50, the consumer may purchase the edited content. The purchase information on the purchase of the edited content may be provided to the consumer information management part 34. The consumer information management part 34 may manage a record of purchased contents. In addition, the sale information is provided to the provider information management part 14 and is included in a sale record of Content provider CPB who has uploaded Content B. Herein, unlike the first embodiment, the sale information may be provided as an amount excluding a predetermined commission.

In addition, the consumer may select the edited content generated by the editing tool (ET) to upload the edited content to the content source 100 for sale. The process of a sale of the edited content by the consumer may be understood to be the same as the process of a sale by a content provider, so a redundant description will be omitted.

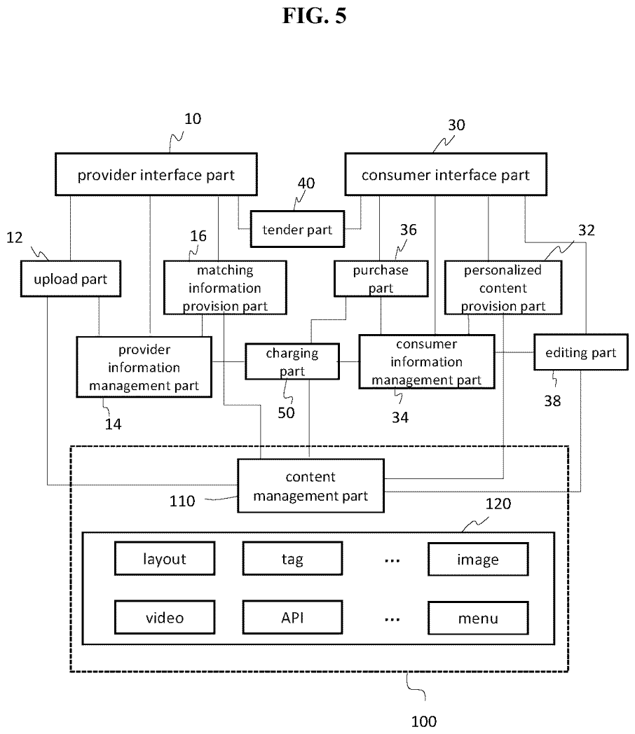

In the meantime, the third embodiment and the fourth embodiment may be described with reference to the block diagram of FIG. 5. Compared to FIG. 2, the block diagram of FIG. 5 has the editing part 38 deleted and a tender part 40 added.

In FIG. 5, the consumer interface part 30 forms an interface for a tender through the consumer interface page, and the provider interface part 10 forms an interface for a tender through the provider interface page.

The tender part 40 provides a tender tool for relaying a tender between a consumer and a content provider to the consumer interface page of the consumer interface part 30 and the provider interface page of the provider interface part 10.

The tender tool (TT) of the tender part 40 makes an edit request of the consumer interface part 30 for a personalized content, an order request of the provider interface part 10 in association with the edit request, an editing order from the consumer interface part 30 in association with the order request, a delivery of an edited content by the provider interface part 10 in association with the editing order, and provision of the edited content delivered to the consumer interface part 30.

When the editing order is made, the tender part 40 may make a request to the purchase part 36 for deposit processing for a portion of an order total, the purchase part 36 provides purchase decision information for the order total according to the purchase of the edited content or for a deposit corresponding to the deposit processing according to a cessation of the purchase of the edited content.

To this end, the charging part 50 sets a deposit in response to a deposit processing request of the tender part 40, and generates purchase information and sale information for the order total or the deposit in association with the purchase decision information of the purchase part 36.

The others excluding the above-described elements of the embodiment of FIG. 5 may be understood with reference to FIG. 2, so a redundant description will be omitted.

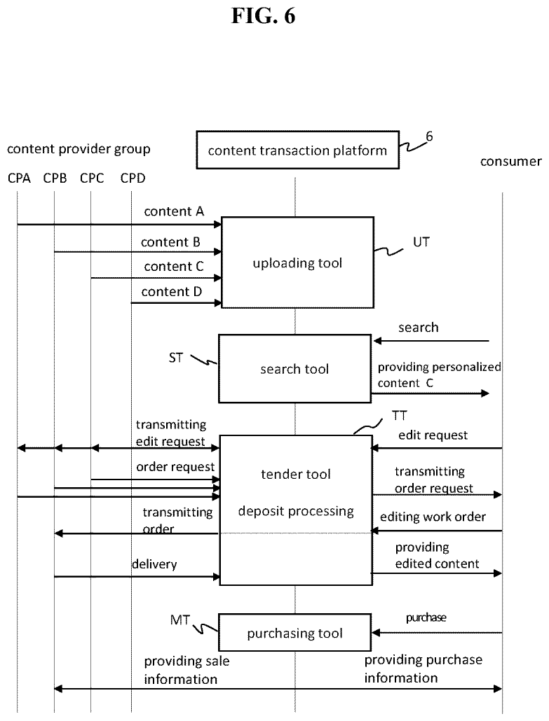

The third embodiment will be described with reference to FIG. 6. In FIG. 6, uploading contents by a content provider group and searching for a content by a consumer are the same as in FIGS. 3 and 4, so a redundant description thereof will be omitted.

In FIG. 6, the personalized content provision part 32 provides a personalized content using a plurality of contents to a consumer through the search tool (ST). As a specific example, the personalized content provision part 32 may select Content C including Content A and Content B as a personalized content, and may provide Content C that is the personalized content to the consumer.

The consumer may select Content C that is the personalized content, and may invite tenders about a request for an editing work on the personalized content.

That is, according to the consumer's selection, the consumer interface part 30 may provide, to the tender part 40, an edit request for requesting the editing work on the personalized content.

In response to the request for the editing work, the tender tool (TT) transmits the edit request for requesting the editing work to Content providers CPA and CPB of a plurality of contents (Content A and Content B) related to Content C and Content provider CPC of Content C that is the personalized content.

The selected content providers CPA, CPB, and CPC may make the order requests for requesting the editing work through the tender tool (TT), and the tender tool (TT) transmits the order requests to the consumer interface part 30. Herein, the order requests may be set to be made and price tenders therefor may be set to be invited within a time limit preset by the consumer.

The consumer may select a content provider to which the request for the editing work is made, among Content providers CPA, CPB, and CPC and may place an order for the edit request for requesting the editing work through the tender tool (TT). Herein, the consumer may transmit the details of editing through the tender tool (TT).

In addition, when the editing order is made, the tender part 40 makes a request to the purchase part 36 for deposit processing for a portion of the order total through the tender tool (TT). The purchase part 36 provides the purchase decision information for the deposit corresponding to the deposit processing so as to prevent the content provider's loss due to a cessation of the purchase by the consumer. The deposit may be understood to be for general escrow payments.

When the consumer selects Content provider CPB, the tender tool (TT) transmits the consumer's order to Content provider CPB.

Content provider CPB creates an edited content obtained by editing Content C to meet the details of editing transmitted through the order and delivers the edited content through the tender tool (TT). The tender tool (TT) may provide the edited content to the consumer through the consumer interface part 30.

The consumer may store the edited content provided to the consumer interface part 30, and then may purchase the edited content through the purchase tool (MT).

If the consumer receives the edited content and ceases the purchase, the purchase part 36 may provide the purchase decision information for the deposit that is the portion of the order total subjected to deposit processing and the charging part 50 may generate payment information and sale information for the deposit. Therefore, the content provider is able to keep the deposit.

When the consumer performs the purchase normally, the purchase part 36 may obtain payment information from the consumer information management part 34 in association with the purchase of the edited content by the consumer, and may provide the purchase decision information including the payment information to the charging part 50.

In addition, the charging part 50 performs charging processing for the purchase of the edited content in association with the purchase decision information of the purchase part 36 and generates purchase information and sale information, and provides the purchase information to the consumer information management part 34 and the sale information to the provider information management part 14.

In the third embodiment, “a request for an editing work” may be understood to be determining whether to perform the editing work, and an editing work order may be understood to be making a request to a selected content supplier for actual editing.

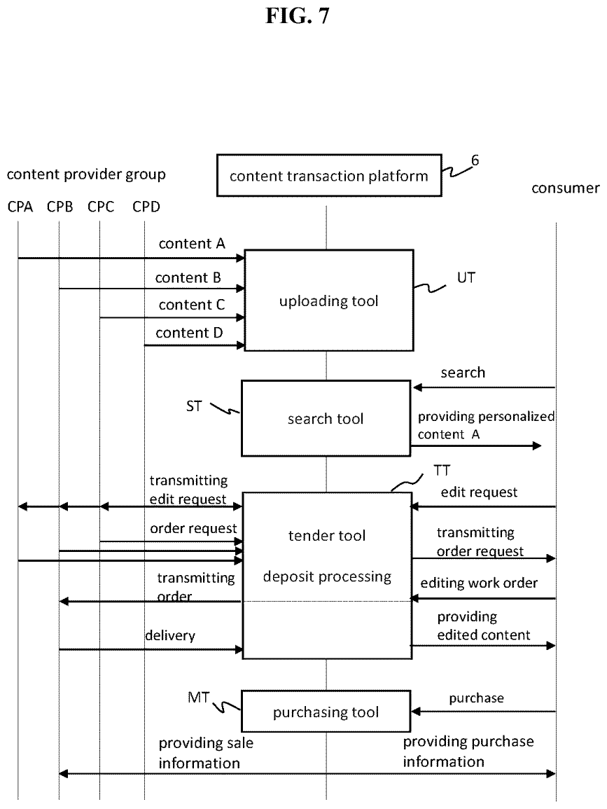

In the meantime, the fourth embodiment will be described with reference to FIG. 7. In FIG. 7, uploading contents by a content provider group and searching for a content by a consumer are the same as in FIGS. 3 and 4, so a redundant description thereof will be omitted.

In FIG. 7, the personalized content provision part 32 provides Content A as a personalized content to the consumer through the search tool (ST).

The consumer may select Content A that is a personalized content, and may provide an edit request in which the details of editing of Content A that is the personalized content is input, to the tender part 40 through the tender tool (TT) of the consumer interface part 30.

The tender part 40 may transmit the edit request to a plurality of content providers for competitive tenders through the tender tool (TT). Herein, the plurality of content providers may be selected randomly or all content providers may be selected as the plurality of content providers.

When the editing order is made, the tender part 40 makes a request to the purchase part 36 for deposit processing for a portion of the order total through the tender tool (TT). The purchase part 36 provides the purchase decision information for the deposit corresponding to the deposit processing so as to prevent the content provider's loss due to a cessation of the purchase by the consumer.

When the consumer selects Content provider CPB, the tender tool (TT) transmits the consumer's order to Content provider CPB.

When receiving the order, Content provider CPB creates an edited content obtained by editing Content A to meet the details of editing and delivers the edited content through the tender tool (TT). The tender tool (TT) may provide the edited content to the consumer through the consumer interface part 30.

The consumer may store the edited content provided to the consumer interface part 30, and then may purchase the edited content through the purchase tool (MT).

When the consumer performs the purchase, the purchase part 36 may obtain payment information from the consumer information management part 34 in association with the purchase of the edited content by the consumer, and may provide the purchase decision information including the payment information to the charging part 50.

In addition, the charging part 50 performs charging processing for the purchase of the edited content in association with the purchase decision information of the purchase part 36 and generates purchase information and sale information, and provides the purchase information to the consumer information management part 34 and the sale information to the provider information management part 14.

In the fourth embodiment, “an edit request” may be understood to be determining whether to deliver an edited content edited according to the details of editing, and an editing order may be understood to be making a request to a selected content supplier for editing according to the details of editing.

According to the present disclosure, a content transaction platform can realize a sharing economy through autonomous and horizontal transactions of contents between consumers and content providers as in the first to the fourth embodiment.

In addition, according to the present disclosure, an optimal personalized content can be provided to a consumer, thereby effectively connecting contents and consumers.

In addition, according to the present disclosure, an accurate content that a consumer wants can be provided through editing of a personalized content, and content providers can create additional income in a trusted environment.

### INDUSTRIAL APPLICABILITY

Using the present disclosure, a sharing economy through autonomous and horizontal transactions of contents between consumers and content providers can be realized.

What is claimed is:

1. A content transaction platform, comprising:
a content source configured to store and manage contents uploaded by a plurality of content providers;
a consumer interface part configured to provide a consumer interface page through the Internet, the consumer interface page forming an interface for a consumer to search, purchase, and edit the contents;
a personalized content provision part configured to provide a search tool, select one or a plurality of personalized contents among the contents of the content source using consumer pattern information in association with the consumer's search using the search tool, and provide the selected personalized content to the consumer interface part;
an editing part configured to provide an editing tool, generate an edited content through the consumer's editing of the personalized content using the editing tool, and provide the edited content to the consumer interface part;
a purchase part configured to provide a purchase tool, and provide purchase decision information including payment information in association with the consumer's purchase of the personalized content or the edited content using the purchase tool; and
a consumer information management part configured to generate the consumer pattern information by collecting and analyzing the consumer's behaviors for the search through the consumer interface part and the consumer's interest levels in the contents provided through the search tool, and manage purchase information corresponding to the purchase decision information.

2. The content transaction platform of claim 1, wherein the consumer information management part is configured to analyze the behaviors and the interest levels of the consumer by collecting previously collected interest fields of the consumer, keywords used by the consumer for the search, and categories and information of the contents read by the consumer.

3. The content transaction platform of claim 1, wherein the consumer information management part is configured to
manage basic information including personal information of the consumer, financial information of the consumer for the purchase, and the consumer pattern information, and
generate the consumer pattern information further using the basic information, and
the financial information includes the payment information for the purchase and the purchase information corresponding to a result of performing charging processing on the purchase decision information.

4. The content transaction platform of claim 1, wherein the editing part is configured to upload the edited content generated by the editing tool to the content source through the consumer's selection, and
the consumer information management part is configured to store selection information of the selected personalized content and editing information of the edited content resulting from editing, provide the selection information and the editing information to the purchase part so that the selection information and the editing information are included in the payment information for the purchase, and receive sale information as the edited content is purchased by another consumer and give a notification through the consumer interface part.

5. The content transaction platform of claim 1, further comprising:
a provider interface part configured to provide a provider interface page through the Internet, the provider interface page forming an interface for the content provider to upload the content and collect information;
an uploading part configured to provide an uploading tool, the uploading tool uploading the content to the content source in response to an upload request of the content provider;
a matching information provision part configured to search the plurality of contents of the content source to provide content information corresponding to request information including a condition pre-registered by the content provider; and
a provider information management part configured to manage and provide the request information of the content provider to the matching information provision part, and manage uploading information of the content and sale information corresponding to the purchase information of the consumer.

6. The content transaction platform of claim 5, further comprising
a charging part configured to perform charging processing in association with the purchase decision information of the purchase part,
wherein the charging part is configured to generate the purchase information and the sale information corresponding to the charging processing, provide the purchase information to the consumer information management part, and provide the sale information to the provider information management part.

7. The content transaction platform of claim 6, wherein the provider information management part is configured to manage the request information, the uploading information, the sale information, basic information including personal information of the content provider, and financial information of the content provider, and
the financial information includes the payment information to be provided to the charging part for the charging processing.

8. A content transaction platform, comprising:
a content source configured to store and manage contents uploaded by a plurality of content providers;
a consumer interface part configured to provide a consumer interface page through the Internet, the consumer interface page forming an interface for a consumer to search the contents, invite tenders, and purchase the contents;
a provider interface part configured to provide a provider interface page through the Internet, the provider interface page forming an interface for the content provider to upload the content and make the tender;
an uploading part configured to provide an uploading tool, the uploading tool uploading the content to the content source in response to an upload request of the content provider;
a personalized content provision part configured to provide a search tool, select one or a plurality of personalized contents among the contents of the content source using consumer pattern information in association with the consumer's search using the search tool, and provide the selected personalized content to the consumer interface part;
a tender part configured to provide a tender tool for relaying the tender between the consumer and the content provider, the tender tool making an edit request of the consumer interface part for the personalized content, an order request of the provider interface part in association with the edit request, an editing order from the consumer interface part in association with the order request, a delivery of an edited content by the provider interface part in association with the editing order, and provision of the edited content delivered to the consumer interface part;
a purchase part configured to provide a purchase tool, and provide purchase decision information including payment information in association with the consumer's purchase of the personalized content or the edited content using the purchase tool;
a consumer information management part configured to generate the consumer pattern information by collecting and analyzing the consumer's behaviors for the search through the consumer interface part and the consumer's interest levels in the contents provided through the search tool, and manage purchase information corresponding to the purchase decision information; and
a provider information management part configured to manage uploading information of the content and sale information corresponding to the purchase information of the consumer.

9. The content transaction platform of claim 8, wherein the tender part is configured to make a request to the purchase part for deposit processing for a portion of an order total when the editing order is made, and
the purchase part is configured to provide the purchase decision information for the order total according to the purchase of the edited content or for a deposit corresponding to the deposit processing according to a cessation of the purchase of the edited content.

10. The content transaction platform of claim 9, further comprising
a charging part configured to perform charging processing in association with the purchase decision information of the purchase part,
wherein the charging part is configured to
set the deposit in association with the request of the tender part for the deposit processing,
generate the purchase information and the sale information for the order total or the deposit in association with the purchase decision information,
provide the purchase information to the consumer information management part, and
provide the sale information to the provider information management part.

11. The content transaction platform of claim 8, wherein the personalized content provision part is configured to provide the personalized content using the plurality of contents,
the consumer interface part is configured to provide the edit request for requesting an editing work on the personalized content to the tender part, and
the tender tool of the tender part is configured to transmit the edit request to the content providers who have uploaded the plurality of contents and the personalized content, in association with the edit request, transmit the order request in association with the edit request to the consumer interface part, and transmit details of editing through the consumer interface part when the editing order is made in association with the order request.

12. The content transaction platform of claim 8, wherein the consumer interface part is configured to provide the edit request in which details of editing of the personalized content is input to the tender part, and
the tender tool of the tender part is configured to transmit the edit request to the plurality of content providers for competitive tenders, and transmit the order request in association with the edit request to the consumer interface part.
